(19) United States
(12) Patent Application Publication
(10) Pub. No.: US 2017/0271137 A1
(43) Pub. Date: Sep. 21, 2017

(54) NETWORKING MASS ANALYSIS METHOD AND DEVICE

(71) Applicant: National Institute of Metrology, China, Beijing (CN)

(72) Inventors: You JIANG, Beijing (CN); Xiang FANG, Beijing (CN); Xingchuang XIONG, Beijing (CN); Zejian HUANG, Beijing (CN)

(73) Assignee: National Institute of Metrology, China, Beijing (CN)

(21) Appl. No.: 15/308,443

(22) PCT Filed: Mar. 23, 2016
(86) PCT No.: PCT/CN2016/077114

§ 371 Date: Nov. 2, 2016

(30) Foreign Application Priority Data
May 5, 2015 (CN) 201510224777.0

(51) Int. Cl. H01J 49/04; H01J 49/06; H01J 49/40; H01J 49/00

(52) U.S. Cl. CPC H01J 49/0404; H01J 49/0031; H01J 49/061; H01J 49/40

(57) ABSTRACT

The invention discloses a networking mass analysis method and device, and belongs to the field of mass spectrometer and ion mass analysis. The device comprises an ion source, an ion transporter, an ion deflector and multiple mass analyzers, wherein the ion transporter is connected with one of the multiple mass analyzers, the multiple mass analyzers are connected with the ion deflector respectively, the ion source produces the ions to be detected, the ions to be detected enter any of the mass analyzers connected with the ion deflector via the ion transporter for mass analysis, and the remaining ions to be detected are transported to the corresponding mass analyzers via the ion deflector for mass analysis. The invention can improve the mass analysis duty ratio of continuous ion sources and obtain more mass-to-charge ratio information of ion beams within each time slot.

### FIELD OF THE INVENTION

The invention relates to the mass spectrometer and ion mass analysis field, in particular to a networking mass analysis method and device.

### DESCRIPTION OF THE RELATED ART

With development of relevant application fields, people need more quick, high sensitivity and multi-function mass spectrometers. However, the mass spectrometer of a single mass analyzer has been difficult to meet various application requirements. Thus, people develop a tandem mass spectrometer which combines multiple mass analyzers to meet these challenges. The tandem mass spectrometer comprises the combination of multiple similar mass analyzers such as an ion trap array, and the combination of different mass analyzers such as an ion trap-Orbitrap mass spectrometer, a quadrupole-time-of-flight mass spectrometer and an ion trap-time-of-flight mass spectrometer. The tandem mass spectrometer enhances analysis efficiency of ion beams, increases ion-ion reaction and ion-molecule reaction functions, and effectively deals with challenges of various applications, however, the problem of the tandem mass spectrometer lies in low mass analysis duty ratio of ions generated by a continuous ion source and low efficiency of simultaneous analysis of ions generated by multiple ion sources. Specifically, on the one hand, the current tandem mass analyzer means axial or radial arrangement of the mass analyzers, and shares an ion transport channel, i.e. ions are transported from the N^{th} mass analyzer to the N+2^{nd} mass analyzer via the N+1^{st} mass analyzer. However, analysis time of different mass analyzers is different during actual application. When a mass analyzer arranged in front of the ion channel is used for mass analysis, subsequent mass analyzers arranged behind the ion channel are certainly hindered to obtain ions. On the other hand, when a mass analyzer performs multistage mass spectrometry, the mass analyzer will choose the ions with one mass-to-charge ratio from the ions generated by the ion source within a period of time for multistage mass spectrometry and the remaining ions will be discarded, which apparently causes loss of information of many ions and reduces the analysis efficiency. Besides, the new applications having developed in recent years such as ion-ion reaction, molecule-ion reaction and light-ion reaction require a mass spectrometer with multiple ion sources, and the mass spectrometer is required to process ions from these ion sources, select ions, obtain product ions for operation, react ions from different ion sources and perform mass analysis successively. However, the current apparatus can be used for time-sharing operation only at low efficiency.

### SUMMARY OF THE INVENTION

For the defects of the prior art, the invention provides a networking mass analysis method and device.

The invention provides a networking mass analysis device comprising

an ion source used for generating ions to be detected;

an ion transporter used for transporting the ions to be detected;

an ion deflector used for controlling deflection of the ions to be detected; and

multiple mass analyzers used for mass analysis of the ions to be detected;

wherein the ion transporter is connected with one of the multiple mass analyzers, the multiple mass analyzers are connected with the ion deflector respectively, the ion source produces the ions to be detected, the ions to be detected enter any of the mass analyzers connected with the ion deflector via the ion transporter for mass analysis (the first mass analyzer to enter is any one of the mass analyzers, not only the mass analyzer directly connected with the ion transporter), and the remaining ions to be detected are transported to the corresponding mass analyzers via the ion deflector for mass analysis.

The ion deflector of the networking mass analysis device has at least three ion inlets/outlets.

The multiple ion sources of the networking mass analysis device are connected with the corresponding multiple ion transporters.

The mass analyzer of the networking mass analysis device comprises a mass analyzer or a combination of a mass analyzer and an ion trap or a combination of multiple mass analyzers.

The networking mass analysis device further comprises a vacuum system, an ion detector, an ion lens and a control system.

For the networking mass analysis device, the ion source, the ion transporter, the mass analyzers, the ion lens, the ion detector and the control system are respectively located in a chamber with different vacuum degrees.

For the networking mass analysis device, the multiple networking mass analysis devices are connected with each other through the ion transporter.

The invention further provides a networking mass analysis method comprising

step 1: obtaining ions to be detected through the ion source, and transporting the ions to be detected to any of the mass analyzers connected with the ion deflector via the ion transporter for mass analysis; and

step 2: transporting the remaining ions to be detected to the ion deflector, applying corresponding voltage to each electrode of the ion deflector to transport the remaining ions to be detected to the corresponding mass analyzer connected with the ion deflector to complete mass detection of the remaining ions to be detected.

For the networking mass analysis method, the ions to be detected enter the mass analyzer via the ion deflector for mass analysis after mass analysis or chemical reaction in any of the mass analyzers.

For the networking mass analysis method, corresponding positive/negative voltage is applied to the ion deflector and the mass analyzer to obtain the cations/anions to be detected for mass analysis.

### BRIEF DESCRIPTION OF THE DRAWINGS

FIG. 1a is a structure drawing of a quadrupole ion deflector;

FIG. 1b is a top sectional view of a quadrupole ion deflector;

FIG. 2a is a schematic diagram of a mass analysis system;

FIG. 2b is a schematic diagram of another mass analysis system;

FIG. 3 is a schematic diagram of the combination of multiple mass analysis systems;

FIG. 4 is a schematic diagram of the structure of a mass spectrometer realizing high duty ratio analysis of multiple characteristic ions from continuous ion sources;

FIG. 5 is a schematic diagram of the structure of a mass spectrometer realizing mass-to-charge ratio information maximization while analyzing ions generated by an ion source within a single time slot;

FIG. 6 is a schematic diagram of the structure of a mass spectrometer realizing rapid switching mass analysis of cations/anions from a single ion source.

### MARKS IN THE ACCOMPANIED DRAWINGS

100—DC lens at inlet of a quadrupole mass filter;
101—RF electrode of a quadrupole mass filter;
102—DC lens at outlet of a quadrupole mass filter;
103—Front end cover of 2D linear RF ion trap 2;
104—RF electrode of 2D linear RF ion trap 2;
105—Rear cover end of 2D linear RF ion trap 2;
106—Radial ion emergency slit of RF electrode of 2D linear RF ion trap 2;
107—Electron multiplier 2;
108—Electron multiplier 1;
109—2D linear RF ion trap 1;
110—Micro-channel plate detector;
111—Time-of-flight mass analyzer;
112—Rear end cover of 3D RF ion trap;
113—RF electrode of 3D RF ion trap;
114—Front end cover of 3D RF ion trap;
115—Electron multiplier 3;
116—Electron multiplier 4;
117—2D linear RF ion trap 1;
118—2D linear RF ion trap 2;
119—2D linear RF ion trap 3;
120—2D linear RF ion trap 4;
121—Quadrupole mass filter 1;
122—Quadrupole mass filter 2;
A, B, C and D are four ion inlets/outlets;
a, b, c and d are four electrodes.

### DETAILED DESCRIPTION OF THE PREFERRED EMBODIMENT

For the problems of the prior art, the invention provides a networking mass analysis method and device, that is, the ion transport channel components consisting of the ion deflection components with three or more ion outlets/inlets and the ion lens are communicated with outlets/inlets of multiple mass analyzers respectively to form a network among the mass analyzers; the control system of the instrument can control ions transported from an ion source or any one of the mass analyzers to reach any one of other mass analyzers via the ion transport channel component; and mass analysis by one mass analyzer does not prevent the ions entering other mass analyzers at next time slot, thus improving mass analysis efficiency of the ion beams generated by the ion source.

In order to achieve the purpose, in terms of core hardware of the device of the invention, the ion deflector is combined with multiple mass analyzers, so that the analysis by one mass analyzer does not prevent subsequent ions entering other mass analyzers, thus improving mass analysis efficiency.

The invention provides a networking mass analysis device comprising

an ion source used for generating ions to be detected;

an ion transporter used for transporting the ions to be detected;

an ion deflector used for controlling deflection of the ions to be detected; and

multiple mass analyzers used for mass analysis of the ions to be detected;

wherein the ion transporter is connected with one of the multiple mass analyzers, the multiple mass analyzers are connected with the ion deflector respectively, the ion source produces the ions to be detected, the ions to be detected enter any of the mass analyzers connected with the ion deflector via the ion transporter for mass analysis (the first mass analyzer to enter is any one of the mass analyzers, not only the mass analyzer directly connected with the ion transporter), and the remaining ions to be detected are transported to the corresponding mass analyzers via the ion deflector for mass analysis.

The ion deflector of the networking mass analysis device has at least three ion inlets/outlets.

The multiple ion sources of the networking mass analysis device are connected with the corresponding multiple ion transporters.

For the networking mass analysis device, the mass analyzer comprises a mass analyzer or a combination of a mass analyzer and an ion trap or a combination of multiple mass analyzers (any one of the mass analyzers and the combination of any one of the mass analyzers can be included, and the mass analyzer is not limited to the 3D ion trap+time of flight, the 2D RF ion trap of a quadrupole mass filter, FTICR, Orbitrap, etc.).

The networking mass analysis device further comprises a vacuum system, an ion detector, an ion lens and a control system.

For the networking mass analysis device, the ion source, the ion transporter, the mass analyzers, the ion lens, the ion detector and the control system are respectively located in a chamber with different vacuum degrees.

For the networking mass analysis device, the multiple networking mass analysis devices are connected with each other through the ion transporter.

The invention further provides a networking mass analysis method comprising

step 1: obtaining ions to be detected through the ion source, and transporting the ions to be detected to any of the mass analyzers connected with the ion deflector via the ion transporter for mass analysis; and

step 2: transporting the remaining ions to be detected to the ion deflector, applying corresponding voltage to each electrode of the ion deflector to transport the remaining ions to be detected to the corresponding mass analyzer connected with the ion deflector to complete mass detection of the remaining ions to be detected.

For the networking mass analysis method, the ions to be detected enter any of the mass analyzers via the ion deflector for mass analysis after mass analysis or chemical reaction in any of the mass analyzers (including ion-neutral reaction, ion-neutral collision induced dissociation, ion-ion reaction and ion-light reaction).

For the networking mass analysis method, corresponding positive/negative voltage is applied to the ion deflector and the mass analyzer to obtain the cations/anions to be detected for mass analysis.

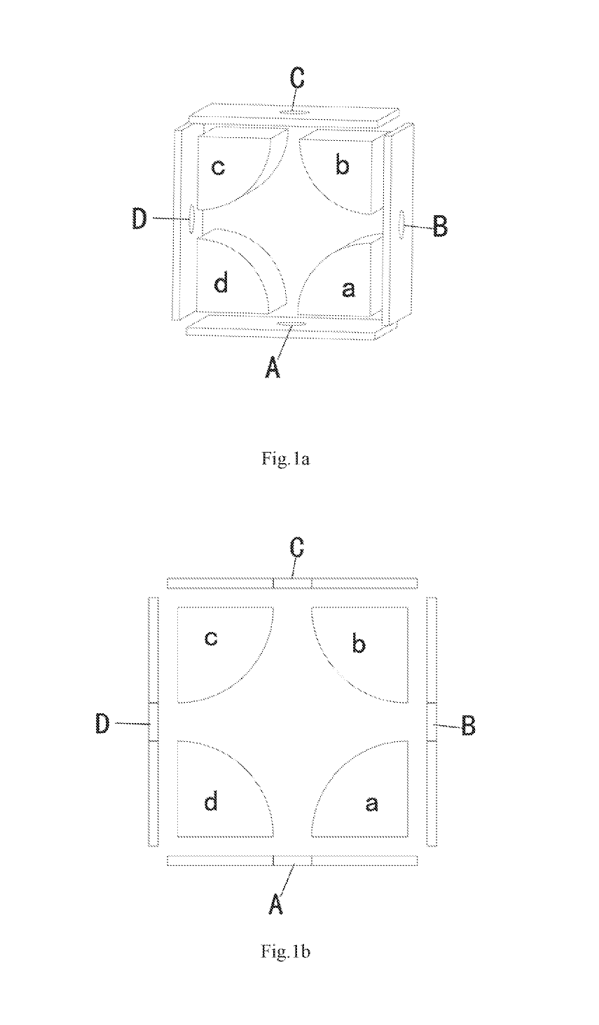

FIG. 1a shows the structure of a quadrupole ion deflector with four ion outlets/inlets, i.e. A, B, C and D which are communicated with each other in the deflector. By controlling voltage applied to four electrodes (a, b, c and d), a beam of ions entering from any one of the ion inlets/outlets can discharge from other ion outlets/inlets; for example, ions entering via port A can discharge from axial port C, port D forming a 90-degree angle with the ion entering direction or port B by deflection. FIG. 1b is the top sectional view of a quadrupole ion deflector.

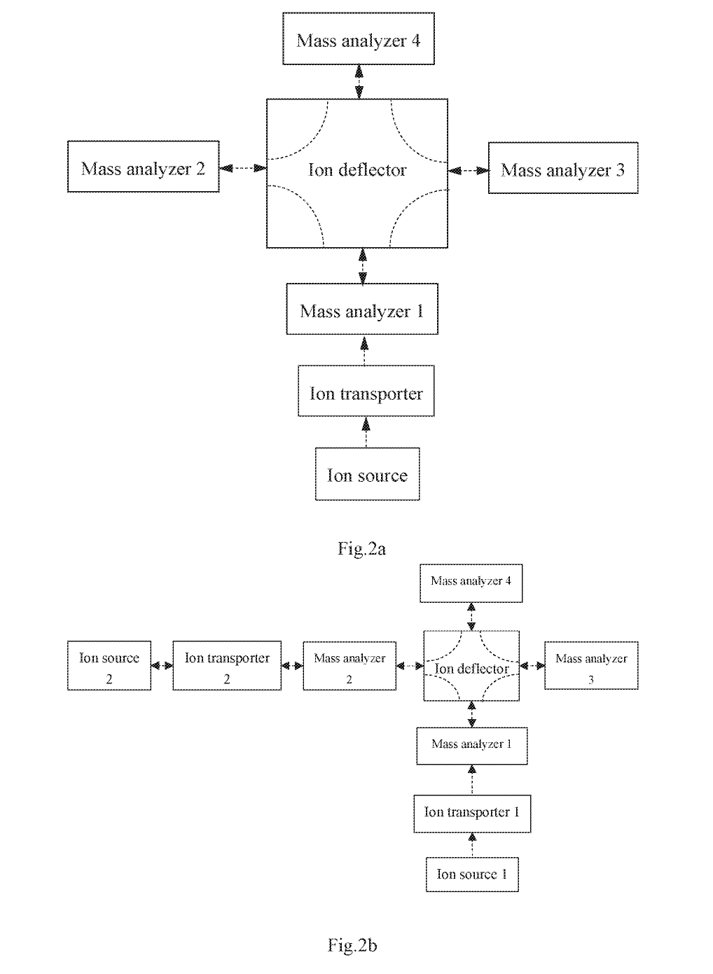

In the invention, a mass analyzer is arranged at each ion outlet/inlet of the ion deflector according to the ion deflection characteristics of the ion deflector, so that one outlet/inlet of the mass analyzer is communicated with one outlet/inlet of the deflector, as shown in FIG. 2a. On this basis, multiple mass analyzers are controlled to analyze ions from one or more ion sources, and the advantages are as follows: the mass analyzers 2, 3 and 4 do not occupy the ion transport channel during mass analysis, that is, when one of the mass analyzers obtain and analyze ions, ions from the ion source can enter another mass analyzer at next time slot. As long as the time required for each mass analyzer to obtain and analyze ions is not more than analysis time of another two mass analyzers, analysis duty ratio of continuous ion beam generated by the ion source can reach 100%; and working frequency of a pulsed ion source can be increased. Although the mass analyzer 1 occupies the ion transport channel, a quadrupole mass filter (continuous mass analyzer) can be used to pre-select ions during analysis with specific object to reach 100% duty ratio of system analysis.

The mass analysis system shown in FIG. 2a can process ions generated by multiple ion sources. As shown in FIG. 2b, ions generated by the ion source 2 enter the mass analysis system via the ion transport device 2 and the mass analyzer 2. Any one or more of the mass analyzers 1, 2, 3 and 4 can analyze ions generated by the ion source 2. The mass analyzers can independently process information of multiple ion sources and mix the acquired ions in a mass analyzer via the ion deflector for anion and cation reaction, etc., thus increasing functions of the instrument.

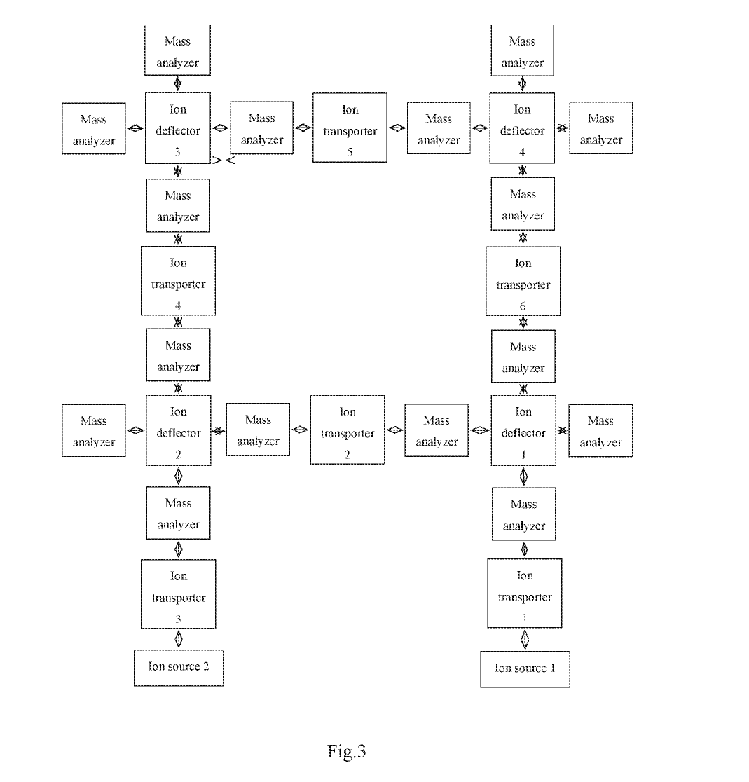

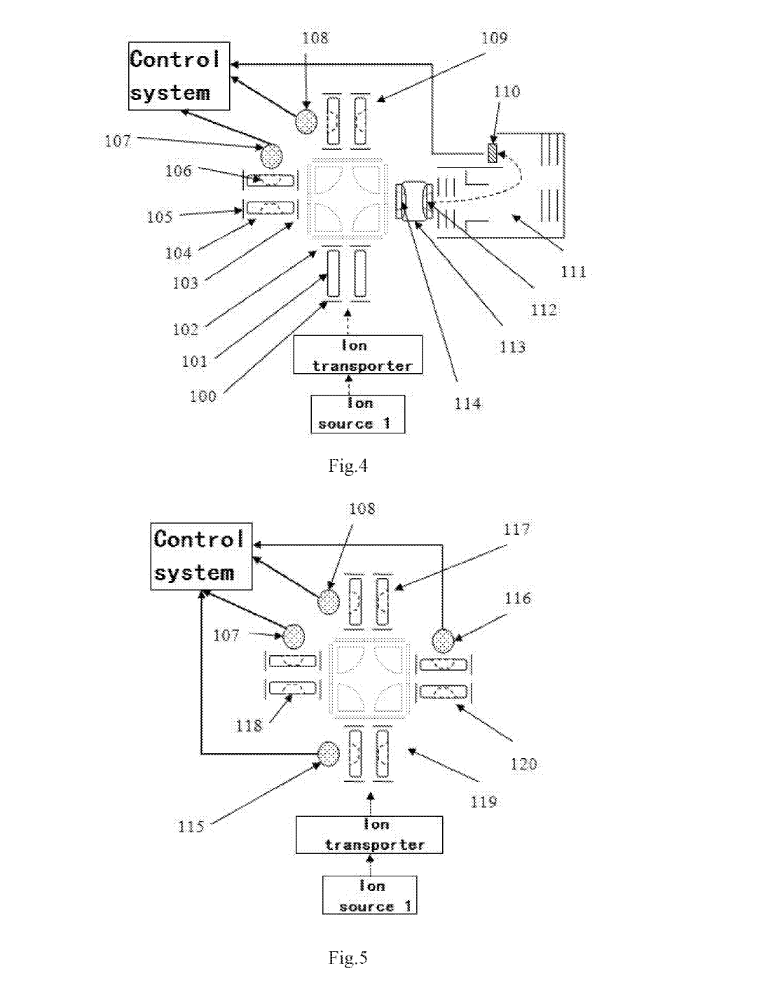

When processing speed of multiple ion sources or mass analyzers is low, analysis duty ratio of the mass analyzer system shown in FIG. 2a and FIG. 2b or its analysis frequency can decrease. In such case, the invention also provides a mass analysis system shown in FIG. 3. FIG. 3 consists of four mass analyzers shown in FIG. 2a, which form a mass analysis network. Each mass analyzer system shown in FIG. 1b is called as one “node” of the mass analysis network, the outlet/inlet of a mass analyzer in each node is communicated with the outlet/inlet of a mass analyzer in another node directly or via the ion transport device, and four nodes can form a mass analyzer network shown in FIG. 3. The mass analyzer network shown in FIG. 3 as well as the mass analysis network formed by more mass analyzer nodes expanded according to the figure can remain high mass analysis duty ratio despite mass analysis requirements with more rapid and complex operating function.

The invention further comprises a networking mass analysis method comprising

obtaining ions to be detected through the ion source, and transporting the ions to be detected to the mass analyzers connected with the ion deflector via the ion transporter for mass analysis; and

transporting the remaining ions to be detected to the ion deflector, applying corresponding voltage to each electrode of the ion deflector to transport the remaining ions to be detected to the corresponding mass analyzer connected with the ion deflector to complete mass detection of the remaining ions to be detected; wherein the ions to be detected enter any of the mass analyzers via the ion deflector for mass analysis after mass analysis in any of the mass analyzers; and corresponding positive/negative voltage is applied to the ion deflector and the mass analyzer to obtain positive/negative ions to be detected for mass analysis.

The technical solution of the invention is described in detail in combination with accompanied drawings and preferred embodiments so as to further understand the purpose, solution and effect of the invention, but the accompanied drawings and preferred embodiments do not limit the protection scope of appended claims of the invention.

Example 1 of the invention is shown as follows:

FIG. 4 shows that port A of a quadrupole ion deflector is communicated with the outlet of a quadrupole mass filter; port B is communicated with one end cover hole of a 3D RF ion trap, and the other end cover hole of the 3D ion trap is communicated with the inlet of a time-of-flight mass analyzer, and ions in the time-of-flight mass analyzer are detected by a detector 3; port C is communicated with the end cover hole of a 2D linear RF ion trap 1, and ions in the 2D linear RF ion trap 1 can be ejected to a detector 1 in radial direction for detection, or can flow from the end cover hole and flow into other mass analyzers via the quadrupole ion deflector; and port D is communicated with a 2D linear RF ion trap 2 which is similar to the 2D linear RF ion trap 1 in terms of function.

The mass analysis process is as follows:

(1-1) Ions consecutively generated by an electrospray ion source are deflected to the port B from the port A of the ion deflector and injected into a tandem mass analyzer composed of a 3D RF ion trap and a time-of-flight mass analyzer under the control of the voltage applied to each ion lens by a control system, and ions generated by the electrospray ion source in time slot T1-1 is under mass analysis over the full mass range by use of high resolution of the time-of-flight mass analyzer, e.g., mass range from 100 Th to 2000 Th (Th: mass-to-charge ratio). The control system processes the mass spectrometric data obtained from the detector 3, and identifies the mass-to-charge ratios mz1 and mz2 of two types of characteristic ions.

(1-2) Then the control system changes the electrode voltage of the ion deflector to make the ions generated by the electrospray ion source in time slot T1-2 axially pass through port C via port A, and then ions are injected into the 2D linear RF ion trap 1. The 2D linear RF ion trap 1 captures ions injected in time slot of T1-2 and performs secondary mass spectrometry, that is, ions with the mass-to-charge ratio mz1 are selected and broken to obtain product ions of mz1, and then product ions are scanned to the detector 1 to generate mass spectrum signal which is stored and processed by the control system. It can be seen that 2D linear RF ion trap 1 needs certain time to perform secondary mass spectrometry after the time slot T1-2. Generally, selection of ions takes tens of milliseconds, collision and dissociation take tens of milliseconds, and scanning to the detector takes tens of milliseconds to hundreds of milliseconds.

(1-3) The control system immediately changes the voltage of each electrode of the ion deflector after the time slot T1-2, without waiting for the 2D linear RF ion trap 1 to complete scanning. Ions generated by the electrospray ion source in the subsequent time slot T1-3 are deflect to port D from port A of the ion deflector, and are injected into the 2D linear RF ion trap 2 to perform secondary mass spectrometry for the mass-to-charge ratio mz2.

(1-4) After time slot T1-3, the control system directly changes the voltage of each electrode of the ion deflector, without waiting for the 2D linear RF ion trap 2 to complete scanning. Then ions generated by the electrospray ion source in the subsequent time slot T1-4 are injected to the 3D ion trap and the time-of-flight mass analyzer for full scanning and analysis. Such analysis can last until any one of the 2D linear RF ion trap 1 and 2D linear RF ion trap 2 ends analysis, the mass-to-charge ratio of the characteristic ions are immediately extracted based on the new full scan mass spectrometric data for a new round of secondary mass spectrometry.

(1-5) It should be further noted that the quadrupole mass filter in FIG. 4 has a mass-to-charge ratio selection function, mz1 or mz2 can pass through the quadrupole mass filter when ions are injected into the 2D linear RF ion traps respectively, so that the ions in the 2D linear RF ion traps have only one mass-to-charge ratio, and tens of milliseconds can be saved for the operation after the 2D linear RF ion traps capture ions.

If secondary product ions is required from the 2D linear RF ion trap with high resolution, the product ions generated in the 2D linear RF ion traps cannot be directly scanned, and the electrode voltage of the trap is controlled to flow from a small end cover hole and enter the ion deflector, ions are controlled to flow from the port B and enter the 3D RF ion trap-time-of-flight mass analyzer for high resolution detection by setting the electrode voltage of the ion deflector, and the time sequence required for change in the electrode voltage is completed by the control system.

The 3D RF ion trap also can finish multistage mass spectrometry, and can involve in analysis in (1-1) to (1-4) to process secondary mass spectrometry of more characteristic ions.

The high resolution mass analyzer used in FIG. 4 is a time-of-flight mass analyzer, and other suitable devices include FTICR mass analyzer and Orbitrap mass analyzer.

If there are many characteristic ions, for example, 10 characteristic ions are also used in analysis, two or three RF ion traps need time sharing operation, and the analysis duty ratio of ions from a continuous ion source will obviously reduce. The analysis duty ratio can be improved by implementing the method of FIG. 3 to expand the number of nodes of FIG. 2 at this time.

Another example of the invention is shown as follows:

The RF ion traps are characterized by implementing secondary or multistage mass spectrometry to obtain structure information of ions so as to accurately perform qualitative analysis on the ions with some mass-to-charge ratio. Generally, an ion source will generate ions with different mass-to-charge ratios. After the RF ion traps capture ions generated by the ion source in a time slot, implements resonance excitation to select ions with a mass-to-charge ratio left in the trap and removes other ions, and performs multistage mass spectrometry on the remaining ions. It can be seen that most of ion information captured by the RF ion trap within time slot T1 is eliminated during the multistage mass spectrometry, multiple characteristic ions need analysis in actual analysis, and some characteristic ions can last very short time, and have weak signal. Therefore, the ions obtained by the traditional analysis method may be not sufficient for analysis. If the analysis is implemented according to the analysis method in Example 1 of the invention, another RF ion trap is required to analyze the ions with a second mass-to-charge ratio within the time slot T2, and the ions with the second mass-to-charge ratio can not be obtained in the time slot T1.

For this problem, more mass-to-charge ratio information can be obtained by the new analysis method proposed in the invention. FIG. 5 shows the hardware configuration for the analysis method. One 2D linear RF ion trap is arranged at each of four outlets/inlets of the quadrupole ion deflector, the outlets/inlets of the deflector is communicated with one end cover hole of each 2D linear RF ion trap, the ions in the 2D linear RF ion traps can be radially scanned to corresponding detectors and converted into electric signals which are stored and processed by the control system. The mass analysis process is as follows:

(2-1) Ions generated by an electrospray ion source within time T1 are captured by any one of 2D linear RF ion traps, and it is assumed that the ions are captured by a 2D linear RF ion trap 1.

(2-2) Within time T1-1, the voltage applied to each electrode of the ion deflector has been set by the control system to be the parameter suitable for ions to deflect from port C to port D, and the voltage applied to the 2D linear RF ion trap 2 is also set to be the parameter suitable for capturing ions;

(2-3) Within time T1-2, the mass-to-charge ratio ejection function is axially selected by use of the 2D linear RF ion traps, and the ions with the mass-to-charge ratio mz1 are axially excited to flow into the port C of the ion deflector from the end cover hole of the 2D linear RF ion trap 1; the ions will enter the 2D linear RF ion trap 2 and then are captured by the 2D linear RF ion trap 2 under the action of electric field; subsequently, the 2D linear RF ion trap 2 will perform multistage mass spectrometry on the mass-to-charge ratio mz1.

(2-4) Within time T1-3, after the ions with the mz1 are completely captured by the 2D linear RF ion trap 2, the 2D linear RF ion trap 1 immediately excites the ions with mz2 to axially flow from the end cover hole of the 2D linear RF ion trap 1 and flow to the port C of the deflector, without waiting for the 2D linear RF ion trap 2 to complete multistage mass spectrometry; meanwhile, the voltage applied to each electrode of the ion deflector is set to be the parameter for making the ions flow to the port A from the port C, and the electrode voltage of the 2D linear RF ion trap 3 is also set to be the parameter for capturing the ions; therefore, the ions with the mass-to-charge ratio mz2 in the 2D linear RF ion trap 1 will flow to the 2D linear RF ion trap 3 and will be captured; subsequently, the 2D linear RF ion trap 3 will perform multistage mass spectrometry on the ions with the mass-to-charge ratio mz1.

(2-5) Within time T1-4, after the ions with the mz2 are completely captured by the 2D linear RF ion trap 3, the 2D linear RF ion trap 1 immediately excites the ions with mz3 to axially flow from the end cover hole of the 2D linear RF ion trap 1 and flow to the port C of the deflector, without waiting for the 2D linear RF ion trap 3 to complete multistage mass spectrometry; meanwhile, the voltage applied to each electrode of the ion deflector is set to be the parameter for making the ions flow to the port B from the port C, and the electrode voltage of the 2D linear RF ion trap 4 is also set to be the parameter for capturing the ions; therefore, the ions with the mass-to-charge ratio mz2 in the 2D linear RF ion trap 1 will flow to the 2D linear RF ion trap 4 and will be captured; subsequently, the 2D linear RF ion trap 4 will perform multistage mass spectrometry on the ions with the mass-to-charge ratio mz1.

(2-6) Within time T1-5, if ions with a characteristic mass-to-charge ratio to be subject to multistage mass spectrometry are left, the multistage mass spectrometry will be performed in the 2D linear RF ion trap 1; if ions with multiple characteristic mass-to-charge ratios requiring analysis are left, the control system will sort the idle mass analyzers and repeat the operations in (2-1) to (2-5) until the ions with the characteristic mass-to-charge ratios are analyzed.

(2-7) After all the characteristic ions in the ions captured within time T1 are analyzed, the control system will use an idle 2D RF ion trap to capture ions within time T2, and repeat analysis from the operating procedures (2-1) to (2-7).

(2-8) It should be further noted that the multistage mass spectrometry is not necessarily and immediately performed after some 2D linear RF ion trap captures ions with some selected mass-to-charge ratio transported within time T1, and the ions can be stored only. The multistage mass spectrometry is implemented after the ions with the same mass-to-charge ratio selected after waiting for time slot T2, T3 and even more time are stored for multiple times and enter the 2D linear FR ion trap, which can improve the sensitivity of analysis.

The ions existing in a period of time (Tk) between the time slot T1 and T2 are not analyzed according to the analysis method. Such period of time Tk is related to the number of the characteristics ions. Generally, the characteristic ions with a mass-to-charge ratio are transported among the mass analyzers for microseconds to sub-milliseconds which are shorter than the scanning time lasting dozens of milliseconds to hundreds of milliseconds. If there are many characteristic ions, the mass analysis duty ratio will be obviously reduced. At this time, the number of the nodes shown in FIG. 5 can be expanded according to the method shown in FIG. 3 to form larger mass analysis network, and all nodes capture ions generated by the ion source in adjacent time slot in proper order to improve the mass analysis duty ratio. Meanwhile, the transportation destination of the selected ions are not confined to the mass analyzers in the nodes, but can be transported to the idle mass analyzers in other nodes; and high resolution mass analyzers or tandem high resolution analyzers can be arranged in some nodes for high resolution detection.

Another example of the invention is shown as follows:

When a mass spectrometer is used for mass spectrometry, the existing analysis method for rapidly obtaining cation and anion information of samples is to set high voltage of ion source, high voltage of ion lens, high voltage of mass analyzer and high voltage of dynode of electron multiplier as cation analysis status within time slot T1 so as to obtain cations from the ion source within time slot T2, and stop mass analysis within time slot T3, set all voltages as anion capturing status to obtain anion information of the ion source within time slot T4, and then repeat the operations. As the DC high voltage of the dynode is up to 10 to 20 KV or −10 to −20 KV, the voltage can be stabilized by taking hundreds of milliseconds to one second during switching of positive/negative high voltage (corresponding to time T1 and T3). Relatively, polarity switching of voltages of other parts needs hundreds of microseconds only. The information of the ion source cannot be obtained before stabilization of high voltage of the dynode, which significantly reduces the mass analysis duty ratio of the continuous ion source.

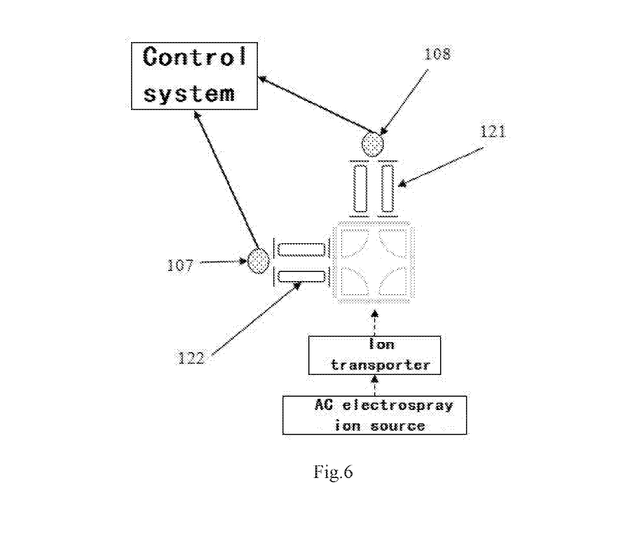

The device and method solutions of the invention shown in FIG. 6 are used for solving such problem, and the mass analysis process is as follows:

(3-1) An AC electrospray ion source produces cations and anions under ambient atmosphere. The voltage of each electrode of ion transportation device and quadrupole ion deflector is set to be in cation transportation mode within time slot T1, and the quadrupole mass filter 1 is set to be in cation analysis mode, the quadrupole mass filter 2 is set to be in cation analysis mode, −1000V high voltage is applied to the electron multiplier 1 (for detecting electrons generated by the dynode 1), −15 KV high voltage is applied to the dynode 1 (for receiving cations to produce electrons), −1000V high voltage is applied to the electron multiplier 2 (for detecting electrons generated by the dynode 2), +15 KV high voltage is applied to the dynode 1 (for receiving anions to produce electrons), and the electrode voltage of the quadrupole deflector is set to be the parameter for making the ions enter from the port A and exit from the port C.

(3-2) The cations are transported from the AC electrospray ion source into the quadrupole mass filter 1 for mass analysis in the time slot T2.

(3-3) In the time slot T3, the voltage of each electrode of the ion transportation device and the quadrupole ion deflector is switched to be in the anion transportation mode, and the deflection direction of the quadrupole ion deflector is set to be the parameter of entering from the port A and exiting from the port D.

(3-4) The anions are transported from the AC electrospray ion source into the quadrupole mass filter 2 for mass analysis in time slot T4.

(3-5) The above mass analysis process is cycled for rapid switching and analysis of continuous ion beams generated by the AC electrospray ion source. As the electrode voltage changed within the time slot T1 and T3 is from dozens of volts to hundreds of volts, the necessary time is hundreds of microseconds only, which can obviously improve the mass analysis duty ratio of ion beams in rapid cation/anion switching and mass analysis in comparison to dozens of milliseconds to hundreds of milliseconds as required in the time slot T2 and T4.

### INDUSTRIAL APPLICABILITY

The networking mass analysis method and device provided in the invention have the following advantages and applicability:

The ion beams generated by the ion source can be distributed to different mass analyzers for analysis in time sequence, and ion transportation and analysis of the mass analyzers do not interfere with each other. In comparison to the existing device and analysis method, the invention can improve the mass analysis duty ratio of continuous ion sources and obtain more mass-to-charge ratio information of ion beams within each time slot.

1. A networking mass analysis device, characterized by comprising:
an ion source used for generating ions to be detected;
an ion transporter used for transporting the ions to be detected;
an ion deflector used for controlling deflection of the ions to be detected; and
multiple mass analyzers used for mass analysis of the ions to be detected;
wherein the ion transporter is connected with one of the multiple mass analyzers, the multiple mass analyzers are connected with the ion deflector respectively, the ion source produces the ions to be detected, the ions to be detected enter any one of the mass analyzers connected with the ion deflector via the ion transporter for mass analysis, and the remaining ions to be detected are transported to corresponding mass analyzers via the ion deflector for mass analysis.

2. The networking mass analysis device according to claim 1, characterized in that the ion deflector has at least three ion outlets/inlets.

3. The networking mass analysis device according to claim 1, characterized in that the multiple ion sources are connected with the corresponding multiple ion transporters.

4. The networking mass analysis device according to claim 1, characterized in that the mass analyzer comprises a mass analyzer or a combination of a mass analyzer and an ion trap or a combination of multiple mass analyzers.

5. The networking mass analysis device according to claim 1, characterized by further comprising a vacuum system, an ion detector, an ion lens and a control system.

6. The networking mass analysis device according to claim 5, characterized in that the ion source, the ion transporter, the mass analyzers, the ion lens, the ion detector and the control system are respectively located in a chamber with different vacuum degrees.

7. The networking mass analysis device according to claim 1, characterized in that a plurality of the networking mass analysis devices are connected with each other through the ion transporter.

8. A networking mass analysis method, characterized by comprising:
step 1: obtaining ions to be detected through the ion source, and transporting the ions to be detected to any of the mass analyzers connected with the ion deflector via the ion transporter for mass analysis; and
step 2: transporting the remaining ions to be detected to the ion deflector, applying corresponding voltage to each electrode of the ion deflector to transport the remaining ions to be detected to the corresponding mass analyzer connected with the ion deflector to complete mass detection of the remaining ions to be detected.

9. The networking mass analysis method according to claim 7, characterized in that the ions to be detected enter the mass analyzer via the ion deflector for mass analysis after mass analysis or chemical reaction in any of the mass analyzers.

10. The networking mass analysis method according to claim 7, characterized in that corresponding positive/negative voltage is applied to the ion deflector and the mass analyzer to obtain cations/anions to be detected for mass analysis.
